(19) United States
(12) Patent Application Publication
(10) Pub. No.: US 2011/0229687 A1
(43) Pub. Date: Sep. 22, 2011

(54) Through Glass Via Manufacturing Process

(75) Inventors: Shiqun Gu, San Diego, CA (US); Xia Li, San Diego, CA (US); Yiming Li, San Diego, CA (US)

(73) Assignee: QUALCOMM INCORPORATED, San Diego, CA (US)

(21) Appl. No.: 12/727,775

(22) Filed: Mar. 19, 2010

(51) Int. Cl. B32B 3/10; B44C 1/22

(52) U.S. Cl. 428/131; 216/41

(57) ABSTRACT

Fabrication of a through glass via in a relatively thick glass substrate includes patterning a through glass via hard mask on a surface of the glass substrate. The fabrication also includes wet etching a portion of the glass substrate, through the hard mask, to create a partial through glass via. The wet etching may involve applying a vapor of an oxide etch chemical, such as HF and XeF6, or applying a wet oxide etch chemical, such as HF and XeF6. The fabrication further includes passivating the etched partial through glass via, removing bottom passivation from the partial through glass via, and repeating the etching, passivating and removing to create the through glass via. The resulting through glass via has a scalloped side wall, a vertical profile and a high aspect ratio.

### TECHNICAL FIELD

The present disclosure generally relates to manufacturing. More specifically, the present disclosure relates to manufacturing through glass vias in glass substrates.

### BACKGROUND

Glass substrates, by themselves and in combination with semiconductor (such as silicon) substrates are becoming more prevalent in electronic device manufacturing. Because glass is less expensive than silicon, the price of a large glass panel would be significantly less expensive than a similarly sized silicon panel. In addition, for some applications, such as radio frequency (RF) applications, glass is a very good material because it has lower signal attenuation (due to high resisitivity of the glass substrate) compared to silicon. When stacking glass substrates to create three dimensional (3D) stacked devices, through glass vias are used.

Etching vias through a semiconductor substrate is well known. For example, through silicon vias have been etched with a Bosch process, as described in U.S. Pat. No. 5,501,893. The Bosch process etches through silicon vias using a plasma etch (e.g., a reactive ion etch (RIE)) to obtain a high aspect ratio via. Because the plasma etch (usually conducted with fluorine based plasmas, such as sulfur hexafluoride (SF6)) has a very high etch rate in silicon, a deep (e.g., 50 or 100 micron deep) via can be fabricated.

The Bosch process initially defines a mask with photoresist. The plasma is then applied to etch a shallow hole in the silicon. The sidewall and bottom of the hole are passivated with a polymer, protecting the side wall, and then the polymer is removed from the bottom of the partial via. The etch and passivation processes repeat until a through silicon via is fabricated. Direct application of the Bosch process can not be implemented with glass, however, because no etch plasma has a high enough etch rate of glass, especially while etching within the same plasma chamber as with other etches of the process.

This Bosch process is inefficient for glass, however, because plasma etches glass at a very slow rate. Thus, other techniques are conventionally employed for etching glass, such as wet etch techniques, for example. However, wet etching is usually an isotropic etching process, resulting in very large vias. Another suggested solution is drilling the via holes using lasers. The advantage of the laser is that deep holes can be drilled. However, because the holes are manufactured one hole at a time, the time to drill many holes will generally be quite extensive, thus, decreasing manufacturing throughput. Moreover, laser drilled holes are relatively large.

Thus, it would be desirable to have a process to etch a relatively vertical via through glass at a high aspect ratio, with a high etch rate.

### BRIEF SUMMARY

According to an aspect of the present disclosure, a method of manufacturing a via in a glass substrate includes patterning a through glass via hard mask on a surface of the glass substrate. The method also includes non-plasma etching a portion of the glass substrate, through the hard mask, to create a partial through glass via. The method further includes passivating the etched partial through glass via. The etching, passivating and removing are repeated to create the through glass via.

In another aspect, a glass substrate has a through glass via with a scalloped sidewall.

The foregoing has outlined rather broadly the features and technical advantages of the present teachings in order that the detailed description that follows may be better understood. Additional features and advantages will be described hereinafter which form the subject of the claims. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent constructions do not depart from the technology of the teachings, as set forth in the appended claims. The novel features which are believed to be characteristic of the teachings, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present teachings, reference is now made to the following description taken in conjunction with the accompanying drawings.

FIG. 1 is a block diagram showing an exemplary wireless communication system in which an embodiment of the present disclosure may be advantageously employed.

FIG. 2 is a flow chart showing an exemplary process for manufacturing through glass vias.

FIGS. 3-6 are cross sectional block diagrams showing various stages of manufacturing a through glass via.

### DETAILED DESCRIPTION

An improved process for manufacturing through glass vias within a glass substrate is explained. This low cost process has a relatively quick etch rate, and results in vias with a relatively small pitch and a relatively high aspect ration.

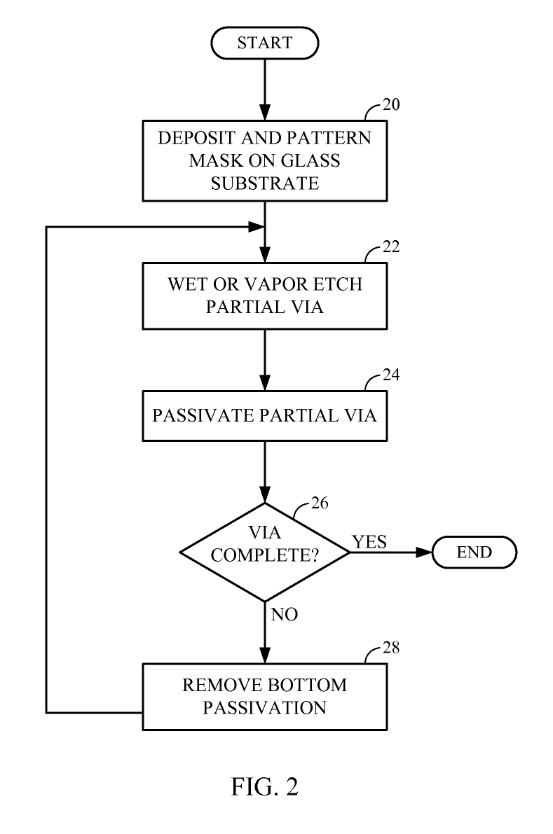

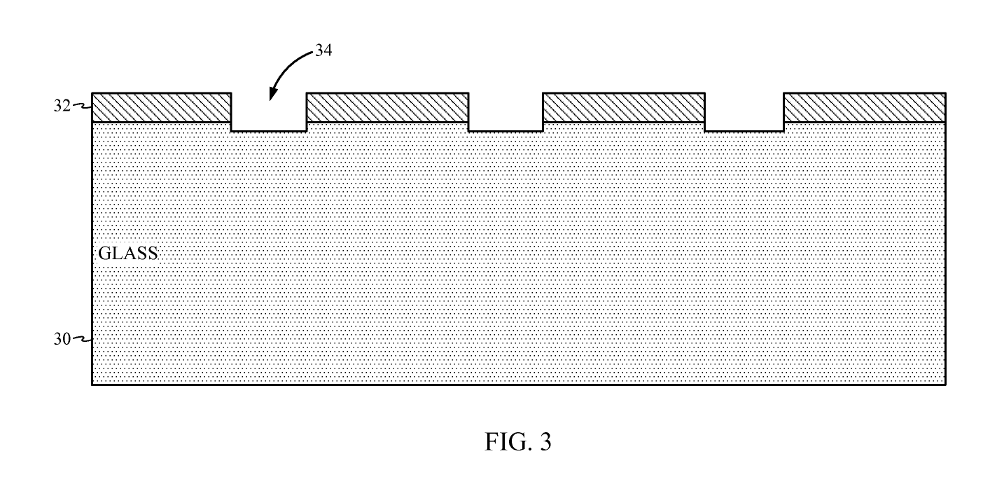

Referring now to FIGS. 2-6, an exemplary process for manufacturing a through glass via will be discussed.

At block 20, a photoresist mask 32 is deposited on a relatively thick glass substrate 30. In one embodiment the glass substrate 30 is approximately 200 microns thick. The photoresist mask 32 is patterned to create openings 34 where the vias will be fabricated. The patterned photoresist becomes a hard mask 32 for the upcoming non-plasma etch. Exemplary materials for the photoresist include silicon nitride (SiN), silicon carbide (SiC), and the like.

At block 22, a vapor of an oxide etch chemical, or a wet oxide etch chemical is applied in a chamber containing the substrate 30 to create a shallow partial via 40. In one embodiment, the partial via 40 is 4 or 5 microns deep. Exemplary etch chemicals for etching the glass substrate 30 include hydrogen fluoride (HF), HF/HCl, HF vapor (containing H20), and the like. The etch is isotropic, thus, only the partial via 40 is created at block 22. Both a vapor oxide etch and a wet oxide etch have a higher density than a plasma etch (as is commonly used for silicon etching), resulting in a faster etch rate on the glass substrate 30. In one embodiment, ultrasonic techniques further enhance the etch rate. Moreover, the vapor etch and wet etch can occur at a normal atmosphere or under high pressure.

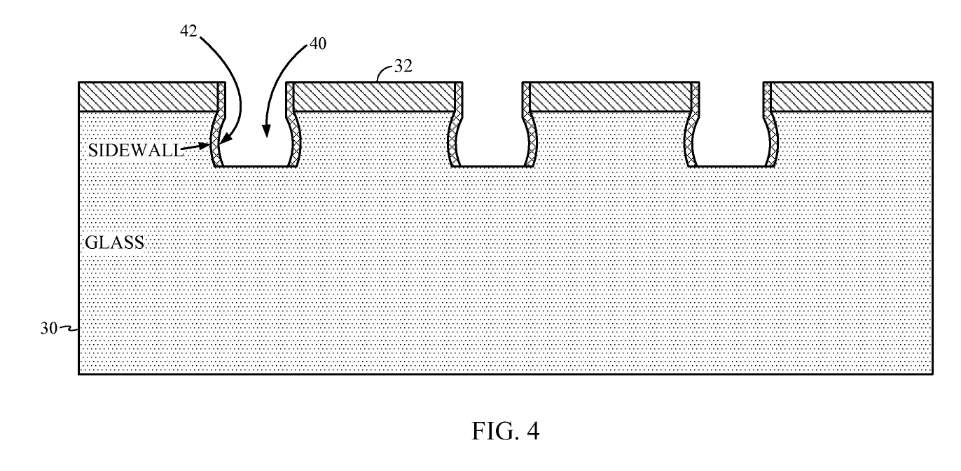

After cleaning the sidewall and bottom of the partial via 40, at block 24, the partial via 40 is passsivated, as illustrated in FIG. 4. Plasma gas (e.g., octafluorocyclobutane (C4F8)) can be used to generate a passivation polymer 42 in another chamber. In other embodiments, a thin layer 42 is deposited to passivate the sidewall and bottom of the partial via 40. For example, the thin layer 42 can be SiN or SiC.

After the partial via 40 has been passivated, it is determined, at block 26, whether the partial via 40 completed the through glass via 50, i.e., whether the through-glass via 50 passes through the entire glass substrate 30. If so, the process ends.

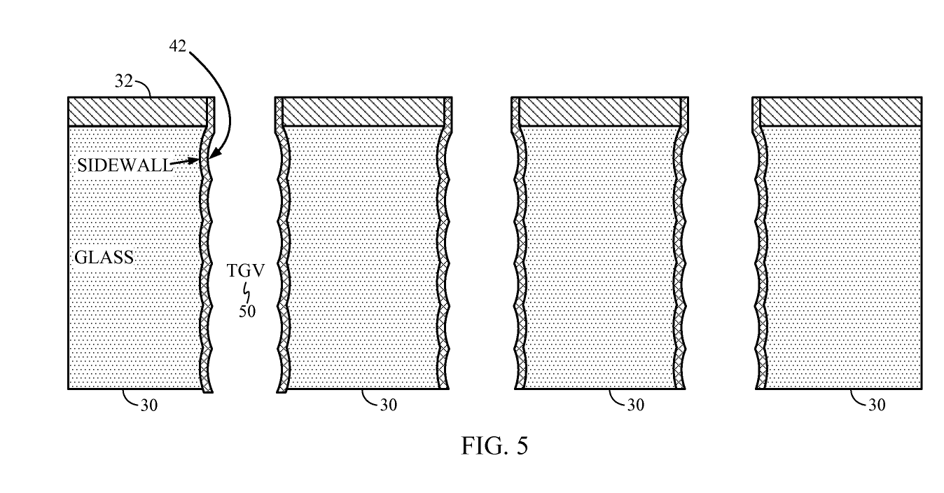

If the through glass via is not yet complete, at block 28, the bottom of the passivation is removed, as illustrated in FIG. 4. In one embodiment, a sputter cleaning process removes the bottom passivation, for example with Argon. Subsequently, blocks 20, 22, 24, 26 and 28 repeat until the through glass via 50 has been completed. As illustrated in FIG. 5, the resulting through glass via 50 has a scalloped side wall and a high aspect ratio (e.g., an aspect ration greater than one).

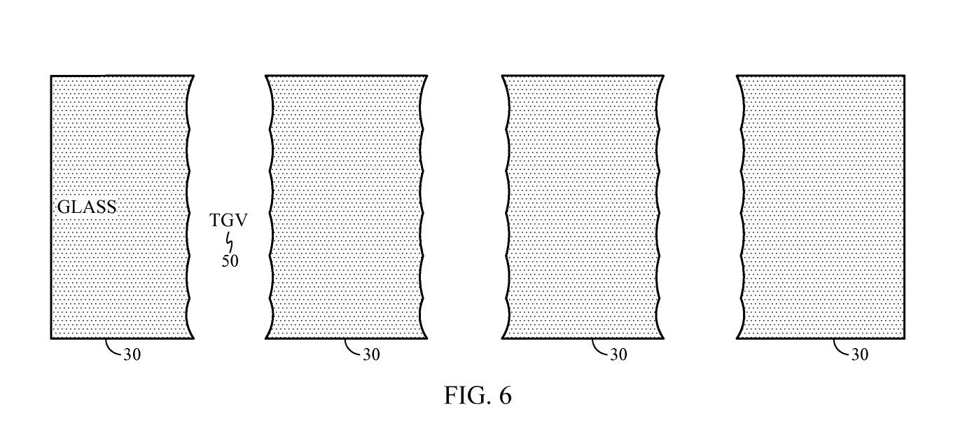

In one embodiment, the hard mask 32 is removed when the passivation is finally removed from the sidewall using a wet cleaning process, as illustrated in FIG. 6. In other embodiments, the hard mask is not removed in order to provide an insulator.

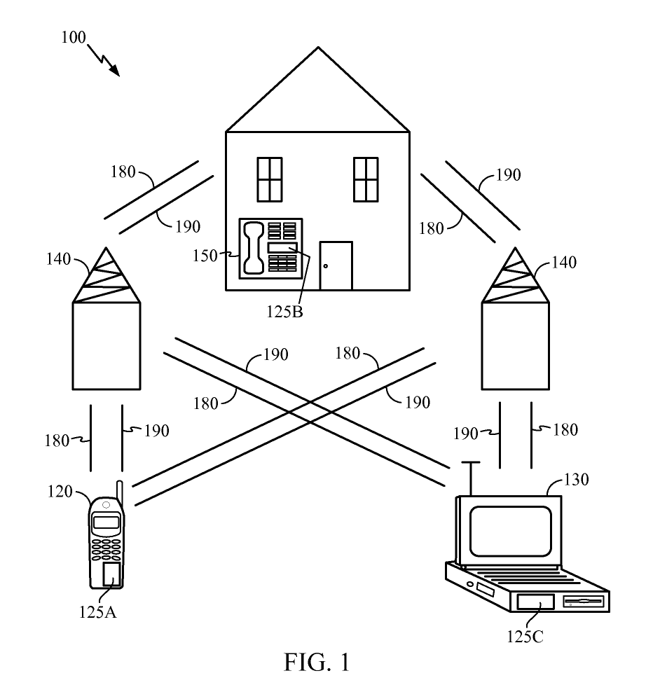

FIG. 1 shows an exemplary wireless communication system 100 in which components having through glass vias may be advantageously employed. For purposes of clarity, FIG. 1 shows three remote units 120, 130, and 150 and two base stations 140. It will be recognized that wireless communication systems may have many more remote units and base stations. Remote units 120, 130, and 150 include components with through glass vias 125A, 125B, and 125C, respectively, which are embodiments of the present teachings, as discussed above. FIG. 1 shows forward link signals 180 from the base stations 140 and the remote units 120, 130, and 150 and reverse link signals 190 from the remote units 120, 130, and 150 to base stations 140.

In FIG. 1, the remote unit 120 is shown as a mobile telephone, the remote unit 130 is shown as a portable computer, and the remote unit 150 is shown as a computer in a wireless local loop system. For example, the remote units may be cell phones, hand-held personal communication systems (PCS) units, portable data units such as personal data assistants, or fixed location data units such as meter reading equipment. Although FIG. 1 illustrates remote units according to the teachings of the disclosure, the disclosure is not limited to these exemplary illustrated units. The disclosure may be suitably employed in any device which includes components having through glass vias.

An improved manufacturing process for through glass vias has been described. The improved process efficiently fabricates small pitch, vertical, through glass vias in a low cost manner. The process is compatible with other back end of line manufacturing processes.

Although the present disclosure and its advantages have been described in detail, it should be understood that various changes, substitutions and alterations can be made herein without departing from the technology of the teachings, as defined by the appended claims. For example, although block 26 is described as being after block 24, block 26 could come before block 24. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present teachings.

Accordingly, the appended claims are intended to include within their scope such processes, machines, manufacture, compositions of matter, means, methods, or steps. The methodologies described herein may be implemented by various components depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies maybe implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

What is claimed is:

1. A method of manufacturing a via in a glass substrate, comprising:
patterning a through glass via hard mask on a surface of the glass substrate;
non-plasma etching a portion of the glass substrate, through the hard mask, to create a partial through glass via;
passivating the etched partial through glass via;
removing bottom passivation from the partial through glass via; and
repeating etching, passivating and removing to create the through glass via.

2. The method of claim 1, further comprising removing the through glass via hard mask.

3. The method of claim 1, further comprising enhancing an etch rate with an ultrasonic process.

4. The method of claim 1, in which the etching comprises applying a vapor of an oxide etch chemical.

5. The method of claim 1, in which the etching comprises applying a wet oxide etch chemical.

6. The method of claim 4, in which the chemical is selected from the group consisting of HF and HF/HCl.

7. The method of claim 5, in which the chemical is selected from the group consisting of HF and HF/HCl

8. The method of claim 1, in which the passivating comprises depositing a film.

9. The method of claim 1, in which the passivating comprises applying a plasma gas to generate a polymer.

10. The method of claim 1, further comprising integrating the glass substrate into at least one of a microprocessor, set top box, music player, video player, entertainment unit, navigation device, communications device, personal digital assistant (PDA), fixed location data unit, and a computer.

11. The method of claim 1, further comprising integrating the glass substrate into a semiconductor device.

12. A glass substrate comprising a through glass via having a scalloped sidewall.

13. The glass substrate of claim 12, in which the through glass via has an aspect ratio greater than one.

14. The glass substrate of claim 12, in which the through glass via has a vertical profile.

15. The glass substrate of claim 12, integrated into at least one of a microprocessor, set top box, music player, video player, entertainment unit, navigation device, communications device, personal digital assistant (PDA), fixed location data unit, and a computer.

16. The glass substrate of claim 12, integrated into a semiconductor device.

17. A method of manufacturing a through glass via in a glass substrate, comprising the steps of:
patterning a through glass via hard mask on a surface of the glass substrate;
wet etching a portion of the glass substrate, through the hard mask, to create a partial through glass via;
passivating the etched partial through glass via;
removing bottom passivation from the partial through glass via; and
repeating etching, passivating and removing to create the through glass via.

18. The method of claim 17, in which the wet etching comprises applying a vapor of an oxide etch chemical.

19. The method of claim 17, in which the wet etching comprises applying a wet oxide etch chemical.

20. The method of claim 17, further comprising integrating the glass substrate into at least one of a microprocessor, set top box, music player, video player, entertainment unit, navigation device, communications device, personal digital assistant (PDA), fixed location data unit, and a computer.
